(19) United States
(12) Patent Application Publication
(10) Pub. No.: US 2012/0085210 A1
(43) Pub. Date: Apr. 12, 2012

(54) Flatbed Die-Cutting Press For Cutting Shapes In Sheets Of Foldable Paper Or Board Material

(76) Inventors: Stephan Wyss, Daniken (SO) (CH); Hans Weber, Stetten (CH)

(21) Appl. No.: 13/375,936

(22) PCT Filed: Jun. 17, 2010
(86) PCT No.: PCT/EP2010/058510

§ 371 Date: Dec. 2, 2011

(30) Foreign Application Priority Data
Jun. 18, 2009 (EP) 09163158.0

(51) Int. Cl. B26D 7/06

(52) U.S. Cl. 83/23; 83/102

(57) ABSTRACT

A flatbed die-cutting press (10) for cutting detailed shapes in sheets (20) of foldable paper or board material that are typically fed at a rate of 6000 to 14000 sheets/hour, comprises a cutting tool assembly (40) having an apertured female die part (42) with a series of apertures (44) defining typically a complex shape or shapes to be cut out. The female die part (42) is associated with a suction channel (46) arranged so that parts (22) that are cut out of the sheets (20) are removable by suction through the apertures (44). This enables the cutting of small shapes and complex shapes whose outline extends over an area of at least several square centimeters that contains a group of cut-outs comprising a plurality of straight or curved lines or strokes all having a section less than 2 mm, possibly less than 1 mm, along all or a substantial part of their length, for the mass production of blanks of paper or board material particularly cigarette packages, where the cut-outs form an emblem on the package.

### FIELD OF THE INVENTION

This invention relates to flatbed die-cutting presses for cutting sheets of foldable paper or board material to produce foldable blanks of the sheet material, comprising a cutting station to which sheets of foldable material to be cut are intermittently delivered one sheet at a time and from which cut sheets are intermittently removed, the press being operable at a rate of up to 3000 sheets/hour or above, typically from 6000-14000 sheets/hour, and wherein the cutting station has a cutting tool assembly with opposite cutting tools that are arranged for relative movement together and apart to cut the sheet material and then release the sheet while it is stationary in the cutting station. The invention also relates to a method of mass producing foldable blanks from sheets of foldable paper or board material having shaped cut outs therein, in such a flatbed die-cutting press.

### BACKGROUND OF THE INVENTION

Flatbed die-cutting and creasing presses are known for example from U.S. Pat. Nos. 3,060,776 and 3,998,452.

Flatbed die cutting relies on a cutting form, containing a cutting blade to cut/stamp out a blank/shape through a process where the blade passes through the material/board and makes contact with the surface of a cutting plate/platen to effect a cut at the cutting station. The final product shape is separated from waste in a second step at a stripping station using special stripping tools.

Such waste stripping stations are for example known from U.S. Pat. Nos. 4,015,495 and 5,605,527.

Currently-available flat bed cutting technology offers the possibility to make cut outs in the board material whose smallest sections have a minimum size of about 2-5 mm at full machine speed. Depending on the complexity of the cut-out, the operating speed of a sheet-fed machine could range from 6000-14000 sheets per hour. The limitation in the minimum size of the cut outs results from the technical means used to remove remaining material (waste). Not only the cut-out size but the shape/design are also limited under industrial conditions. There are holding points (nicks) which keep the waste elements in the cut sheet until the sheet is transferred to the waste removal station. Waste removal is done as a second step after cutting, at a stripping station having a special stripping tool equipped with pins or other waste removing elements. The stripping pins/elements that are used under industrial conditions are usually at least 2 mm in diameter or blades approximately 1 mm in width. If it is attempted to remove waste smaller than about 2 mm in section, on the one hand processed sheet material can be damaged due to mechanical tolerances, and on the other hand the cut out quality and machine running speed cannot be maintained on the required level.

### SUMMARY OF THE INVENTION

An aim of the invention is to overcome limitations of current flatbed die-cutting presses, namely to enable the cutting of parts of foldable sheet material of smaller section and of more complex shapes than was heretofore possible, while not compromising the operating speed.

Accordingly, one aspect of the invention provides an improved flatbed die-cutting press of the above-mentioned type that is adapted to make cut-outs of different possibly complex and detailed shapes and sizes in the foldable sheet material, wherein the cutting tool assembly comprises an apertured female die part having therethrough at least one and preferably a series of apertures defining a shape or shapes to be cut out wherein the shape or shapes to be cut out has a section less than 2 mm, possibly less than 1 mm, and in particular may define a complex shape or shapes to be cut out whose outline extends over an area of at least several square centimeters (i.e. a minimum of 2 cm² and usually more, say 4 cm² or more) that contains a group of cut-outs comprising a plurality of straight or curved lines or strokes all having a section less than 2 mm, possibly less than 1 mm, along all or a substantial part of their length, and the opposite cutting part comprises a protruding male cutter of size and shape corresponding to the aperture(s) of the female die part. Apart from complex shapes, this invention also allows to cut out very small single elements with a surface of about 1 mm2. The male cutter is engageable in the aperture(s) of the female die part to cut out part(s) of the foldable sheet material that have the shape of the aperture(s), with the cut-out part(s) being removable through the aperture(s) in the female die part. Furthermore, the female die part is associated with a suction cavity that leads into the side of the aperture(s) facing away from the cutter, and this suction cavity is connectable to a source of suction whereby parts that are cut out (waste) of the sheet material are removable by suction through said aperture(s) and into the suction cavity before the cut sheet is removed from the cutting station.

In this way, cut out parts of the sheet material are removed from adjacent the cutting die just after cutting has taken place. Removal of small cut out parts is fast enough to guarantee a continuous industrial stable cutting process at nominal machine speed, even for the given cut-outs of complex shape or shapes having parts of very small section.

The invention results in the ability to cut out very small design elements and remove small waste elements in one step in the cutting station (in the so-called autoplatine zone).

The invention provides the possibility to cut out in an industrial way very fine detailed elements down to a minimum size of less than approximately 1 mm in section, even down to about 0.5 mm in section. The shape of the individual cut outs and the pattern or design formed by a group of cut outs is practically without any limitations. Until now it was not possible to achieve such fine cut-outs of different shapes in a flatbed die-cutting press.

The female die part for example has a series of apertures preferably defining the shape of a group of cut-outs in the sheet material whose outline extends over an area of at least several square centimeters, the group of cut-outs including at least one cut-out that has an elongated shape with a section less than 2 mm, possibly less than 1 mm, along all or part of its length.

The invention also provides a cutting tool module of a flatbed die-cutting press as discussed above, which module is fittable in and removable from a cutting station of the flatbed press where it is interchangeable with different cutting plate modules.

Another aspect of the invention is a method of mass producing foldable blanks from sheets of paper or board material having complex shaped cut-outs therein, in a flatbed die-cutting press as discussed above, which method comprises engaging the male cutter in the aperture(s) of the female die part to cut each sheet of the board material with cut-out part(s) having the shape of the aperture(s), and applying suction to the suction cavity whereby parts of the board material that are cut off are removed by suction through the aperture(s) of the female die part and into the suction cavity.

The resulting cut-out sheets of paper or board material can for example each have one or more groups of cut-outs that together form a complex shape or shapes whose outline extends over an area of at least several square centimeters that contains a group of cut-outs comprising a plurality of straight or curved lines or strokes all having a section less than 2 mm, possibly less than 1 mm, along all or a substantial part of their length. Moreover the group of cut-outs can have, between the cut-outs at the periphery of said area, a non-cut out part or parts that is/are connected to the surrounding sheet material.

The above-described inventive method of producing foldable blanks from sheets of paper or board material having complex or simple shaped cut-outs therein, can be followed by a conversion operation preferably in a subsequent pass in the same flatbed die-cutting press equipped with appropriate cutting and creasing dies, followed by a stripping operation to produce a plurality of blanks from each sheet of the board material, such that each blank has one or more cut-outs that each form a shape whose outline extends over an area of several square centimetres.

This can be followed by a folding operation to fold the blanks to produce folded sheet material objects in particular packets, wherein each packet or other folded object has on an outside face at least one area each with one or more cut-outs that constitute an emblem on the outside of the packet or other folded object.

As mentioned, the invention makes it possible to obtain cut-outs of various shapes including cut-outs with very fine sectional sizes down to 1 mm or even less, which was heretofore not possible with flatbed die-cutting presses. This means that folded objects of board material like cigarette packets can be embellished with cut-out shapes having very fine details making it possible to apply cut-out emblems that previously were applied by embossment or printing.

Further aspects of the invention are set out in the claims.

### BRIEF DESCRIPTION OF DRAWINGS

The invention will be further described by way of example with reference to the accompanying schematic drawings in which:

FIG. 1 is a view of a flatbed die-cutting machine equipped with an external suction unit according to the invention;

FIG. 2 is a top view of a cutting plate module according to the invention;

FIG. 3 is a diagrammatic side view showing a cutter coming to engage with an aperture in a female die plate of the cutting plate module, and the removal of cut out parts by suction; and

FIG. 4 shows an example of a cut-out shape obtainable by the inventive method.

### DETAILED DESCRIPTION

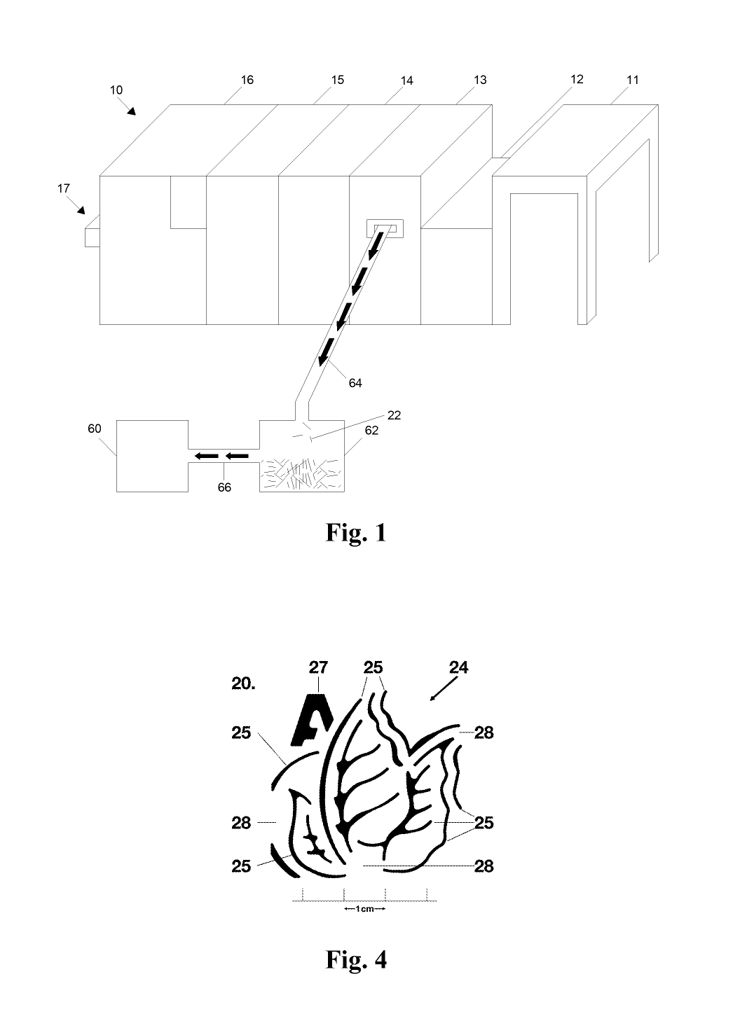

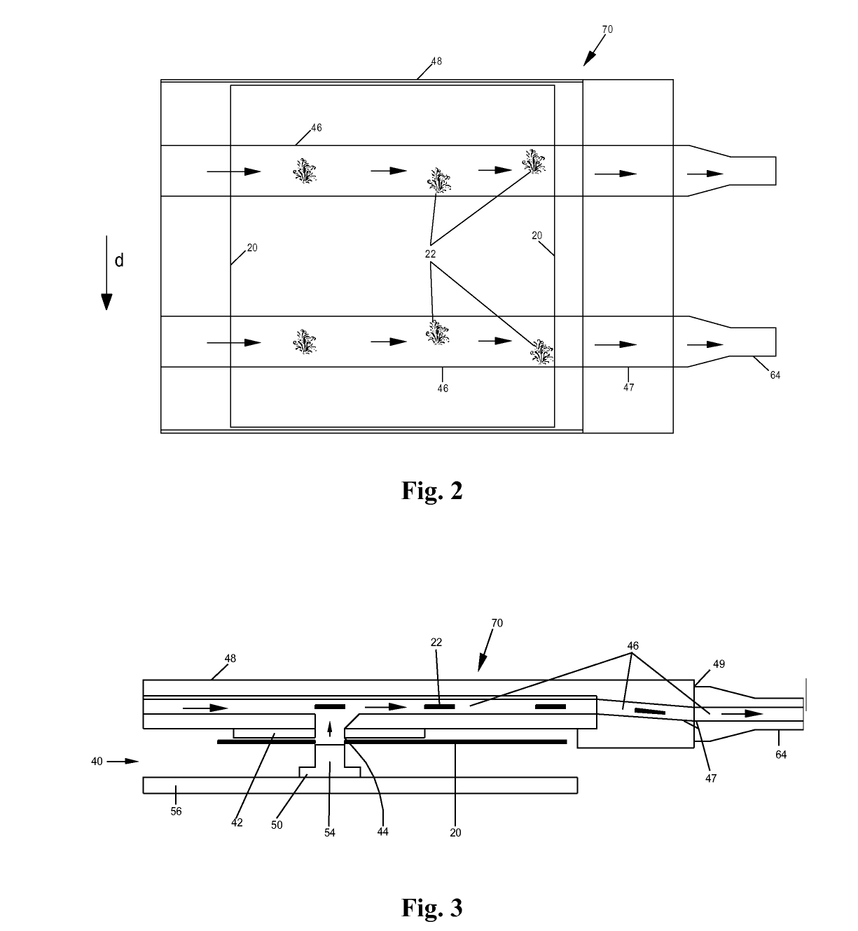

FIG. 1 shows a conventional flatbed die-cutting press 10 that is equipped according to the invention with an external suction source 60 and container 62 for waste material. The press 10 comprises a board storage unit 11 where sheets of foldable board to be cut are piled and delivered to a transfer and infeed unit 12 from where the sheets are intermittently fed one at a time to a converting station 13 where the sheets, in conventional operation, are cut and creased. The cut and creased sheets are then transferred to a stripping station 14 for the removal of waste, then to a station 15 for separation of the blanks and palettisation. Finally, the cut and creased and palettised blanks are transferred to a station 16 for the removal of residual waste, and piles of the thus-processed blanks exit the press at 17.

The means for gripping and intermittently feeding the sheets through the different stations are conventional, and are not shown.

Die-cutting presses of this type are adapted to process sheets of foldable board having a grammage from about 160 g/m2 to about 400 g/m2, typically in the range 180 to 280 g/m2. This corresponds to a thickness in the range of about 180 to 400μ depending on the density of the board material. Typically the press 10 can process boards measuring up to about 1 m by 1.45 m, usually in the size range 1 m by 0.76 m, wherein each sheet of board carries a number of rows and/or columns of blanks that are separated in the final operations. This invention could also be applied to paper from about 80 g/m2 to about 160 g/m2.

The cutting and creasing operations typically produce the blanks of packets like cigarette packets, but many other applications are possible. Of course, the press 10 is adaptable to process many different types of board or paper products. For this, the different stations have removable modules which are adapted to the board being processed and to the design of the cuts and creases to be applied. Thus the converting station 13, which is also known as the autoplatine zone, has two removable modules, one with a cutting and creasing tool, the other with a cutting-counterplate against whose cutting knives on the cutting/creasing tool apply to form cuts or creases at the appropriate locations of the board. Waste which is cut off in the converting station 13 is removed later in the stripping station 14.

With the known conversion process it is not possible to make cut outs which have very narrow cross-sections, and it is not possible to produce cut-outs with a great variety of shapes extending over several square centimeters (i.e. over at least 2 cm²). This constitutes a limitation on the possible applications of the press 10.

According to the invention, this limitation is removed by providing a cutting tool assembly 40 (see FIG. 3) which comprises an apertured female die part 42 having therethrough at least one and preferably a series of apertures 44 defining a shape or shapes to be cut out. For simplicity only one aperture 44 is shown in FIG. 3. The opposite cutting part 50 comprises a protruding male cutter 54 of size and shape corresponding to the aperture(s) 44 of the female die part 42. This male cutter 54 is mounted on a plate 56 that can be driven up and down whereby the cutter 54 is engageable in the aperture(s) 44 of the female die part 42 to cut the sheet 20 of board material to cut out part(s) 22 that have the shape of the aperture(s) 44. The cut-out part(s) 22 are removable through the aperture(s) 44 in the female die part 42.

When the plate 56 is lowered after cutting, the sheet 20 is freed and the cut sheet is transferred by the sheet gripping/transferring means to the stations 14-16 which remain inactive during operation by the inventive method.

The die-cutting press 10 could alternatively operate with the male cutter 54 disposed above the female die part 42. Also, to improve process efficiency, resilient means can be provided to act between the plate 56 and female die part 42 as they come together.

The aperture(s) 44 and female die part 42 can occupy an area of several centimeters by several centimeters, say 3 cm×3 cm or more for producing the shape 24 shown by way of example in FIG. 4. Typically the female die part 42 will be about 2 mm thick and the male cutter will have a height of about 3-4 mm In conventional flatbed die-presses there is a tolerance of approx 0.02 mm between the male/female die parts, and it has been found that this tolerance is acceptable for the very fine patterned designs of the cut-outs available with the present invention.

Each female die part 42 is associated with a suction channel 46 that leads into the side of said aperture(s) 44 facing away from the cutter 54. Suction channel 46 is connectable to an external source of suction 60 (FIG. 1) whereby parts 22 that are cut out of the foldable sheet material are removable by suction through the aperture(s) 44 and into the suction channel 46 as indicated by the arrows, before the cut sheet 20 is removed from the cutting station 13. To collect the removed parts 22 of the sheet material, the suction channels 46 are connected by a tube 64 to an external container 62 which in turn is connected by a tube 66 to the external source of suction 60, as shown in FIG. 1, arranged so that the cut out parts 22 fall into and are collected in the container 62.

The female die part 42 is supported against a flat generally rectangular body 48 made of wood, metal and/or plastics material having therein two channels 46 which form a suction cavity leading into the aperture(s) 44 of female die part 42.

Body 48 has the same dimensions as the conventional plate-like module that is fitted with a counterplate and is inserted in the station 13 when this station is to act as a conversion station. This body 48, with its suction channels 46 and with the female die part 42 supported thereagainst, constitutes a cutting plate module 70 of the die-cutting press 10 that is fittable in and removable from the cutting station 13, where it is interchangeable with different cutting plate modules that can be either inventive modules 70 with apertured female die parts 42 and associated suction channels 46, or conventional conversion modules with non-apertured cutting plates without associated suction channels.

The module's body 48 usually has a plurality of suction channels 46 (two being shown) that lead into apertures 44 in a plurality of female die parts 42, these suction channels 46 joining into a single duct or leading into a corresponding number of ducts 47 that lead into an edge 49 of body 48 for connection to the tube 64 leading to the external source of suction 60.

For many applications, the cutting tool assembly 40 will comprises a plurality of apertured female die parts 42 each having at least one and preferably a series of apertures 44 defining a shape or shapes to be cut out. These female die parts 42 can be arranged in rows and/or columns relative to the direction of delivery d of the sheets 20, in the illustrated example two columns with a row of three female die parts 42 in each column In this case, two suction channels 46 correspond to the two columns of three female die parts 42. Of course, the opposite cutting parts 50 have a plurality of corresponding cutters 54 in register with the apertures 44 in the female die parts 42.

Also, for many applications each female die part 42 can have a series of apertures 44 that define for example the complex shape of a group of cut-outs 24 in the sheet material whose outline extends over an area of at least several square centimeters, say 3 cm by 3 cm or more to produce the cut out shown for example in FIG. 4. Typically, the group of cut-outs 24 includes several elongated cut-outs that each have a shape with a section less than 2 mm, possibly less than 1 mm, along all or part of its length, again as is illustrated by the example of FIG. 4. Of course, the corresponding cutters 54 have complementary shapes and are dimensioned to fit closely in the apertures 44.

The cutting plate module 70 of the flatbed die-cutting press 10 is fittable in and removable from the conversion/cutting station 13 of the flatbed press 10 where it is interchangeable with different cutting plate modules. This inventive module 70 comprises several apertured female die parts 42 having a series of apertures 44 each for example defining a complex shape to be cut out by corresponding cutters 54. The module 70 also has a flat generally rectangular module body 48 on which the female die part 42 is supported with one face facing outwards towards the cutters 54 when the module 70 is fitted in the press's cutting station 13. Lastly, the module 70 has suction channels 46 in the support body 48 that lead into the side of the aperture(s) 44 in the female die part(s) 42 facing away from the cutters 42. The suction channels 46 are connectable to the external source of suction 60 as described above. When the module 70 is fitted in the cutting station 13, during operation of the press 10, parts 22 of the sheet material that are cut out are removable by suction through apertures 44 and into the suction channels 46, as indicated by the arrows.

The female die parts 42 are fitted on the body 48 by screws so they can be removed and fitted with new female die parts 42 with different shaped apertures 44, when needed, so the same module can be adapted to cut different shapes. Likewise the cutting parts 50 with cutters 54 are interchangeable in their module.

The inventive method of producing foldable blanks from sheets of paper or board material having shaped cut-outs 24 therein, in the described flatbed die-cutting press 10, comprises engaging the male cutter 54 in the aperture(s) 44 of the female die part 42 to cut the sheet material with cut out part(s) 24 having the shape of the aperture(s) 44, and applying suction to the suction channel or channels 46 whereby parts 22 that are cut off the sheets 20 are removed by suction through the aperture(s) 44 and into the suction channel(s) 46.

In this method the flatbed die-cutting press 10 typically operates at a rate of up to 14000 sheets/hour, possibly in the range 6000-12000 sheets/hour. Usually the operator will want to set the press to operate at close to the highest operating speed at which no or few rejects are produced, however operation at lower speeds is possible.

FIG. 4 shows purely by way of example a possible complex shape of a cut-out 24, which occupies an area of 3 cm×3 cm or more. The illustrated shape of the cut-out 24 corresponds to the shape of the apertures 44 and the cutter 54 used to produce it. Virtually any required shapes made of a pattern of cut-outs can be produced, including shapes with very fine cut-outs.

The cut out sheet material for example has a group of cut-outs 24 that together form a shape whose outline extends over an area of at least several square centimeters. The group of cut-outs 24 typically includes several elongate cut-outs 25 that each have a shape with a section less than 2 mm, possibly less than 1 mm, along all or part of its length, the group of cut outs having, between the cut-outs at the periphery of said area, a non-cut out part or parts 28 that is/are connected to the surrounding material of the sheet 20.

The group of cut-outs 24 in a given area can for example comprise a plurality of cut out straight lines 27 or curved lines or strokes 25 all having a section less than 2 mm, possibly less than 1 mm, along all or a substantial part of their length. The group of cut-outs can also include parts of larger size and possibly of complex shape, and/or can include straight thick elongate sections like the schematically shown letter “A” 27 if FIG. 4. However, this only represents some possibilities; cut-outs 24 of virtually any shape can be made.

Alternatively, the invention allows the cutting out of small shapes with a surface less than 2 mm by 2 mm, possibly less than 1 mm by 1 mm, for instance of square, circular or oval shape.

Simple small shapes can be cut out for special purposes, or a series of small shapes or perforations can form an array making up a pattern or shapes which extends over several square centimeters.

The inventive method of producing foldable blanks from sheets of paper or board material having shaped cut-outs therein can be followed by a conversion operation, preferably in a subsequent pass in the same flatbed die-cutting press 10 whose conversion station 13 is then equipped with appropriate conventional cutting and creasing dies, followed by a stripping operation in the stripping station 14 of the same press 10 to produce a plurality of foldable blanks from each sheet 20, each blank having one or more cut-outs 24 that each form a shape whose outline typically extends over an area of several square centimetres. Typically, one sheet can produce from say 2-4 blanks (for instance for folded cigarette package stands) up to 15 blanks (5×3) for most packages and up to about 70 blanks for smaller products.

This conversion operation can be followed by a folding operation at the same location or more typically at a remote location, to fold the blanks to produce folded objects in particular packets, wherein each packet or other folded object has on an outside face at least one area each with one or more cut-outs 24 that constitute an emblem on the outside of the packet or other folded object.

The invention is applicable to the production of many different folded articles made of paper or board, such as cigarette or cigar packages, in particular the outer shells of flip-top cigarette packages that have an available space of about 3×5 cm above the mandatory health warning, packages for cosmetics and perfumery, packages for edible products including sweets, sweeteners and chewing gum, as well as stands, presentation holders and display cartons for various products. For all these board products, the invention offers the possibility of mass producing them with cut-out shapes that could not be obtained by known conversion processes using flatbed die-cutters.

1. A sheet-fed flatbed die-cutting press (10) adapted for cutting sheets (20) of foldable paper or board material to produce foldable blanks of the paper or board material, comprising a cutting station (13) to which sheets (20) of foldable material to be cut are intermittently delivered one sheet at a time and from which the cut sheets are intermittently removed, the press being operable at a rate of up to 3000 sheets/hour or above, the cutting station (13) having a cutting tool assembly (40) with opposite cutting parts (42,50) that are arranged for relative movement together and apart to cut each sheet and then release it while the sheet (20) is stationary in the cutting station,
characterized in that
the flatbed die-cutting press is adapted to make cut-outs of different shapes and sizes in the foldable sheet material, and wherein:
the cutting tool assembly (40) comprises an apertured female die part (42) having therethrough at least one and preferably a series of apertures (44) defining a shape or shapes to be cut out wherein the shape or shapes to be cut out has a section less than 2 mm, possibly less than 1 mm, and in particular may define a complex shape or shapes to be cut out whose outline extends over an area of at least several square centimeters that contains a group of cut-outs comprising a plurality of straight or curved lines or strokes all having a section less than 2 mm, possibly less than 1 mm, along all or a substantial part of their length,
the opposite cutting part (50) comprises a protruding male cutter (54) of size and shape corresponding to the aperture(s) (44) of the female die part, the male cutter (54) being engageable in the aperture(s) (44) of the female die part to cut out part(s) of the foldable sheet material that have the shape of the aperture(s) (44), with the cut-out part(s) (22) removable through the aperture(s) (44) in the female die part (42); and
the female die part (42) is associated with a suction cavity (46) that leads into the side of said aperture(s) (44) facing away from the cutter (50), the suction cavity being connectable to a source of suction (60) whereby parts (22) that are cut out of the foldable sheet material are removable by suction through said aperture(s) (44) and into the suction cavity (46).

2. The flatbed die-cutting press of claim 1, wherein the suction cavity (46) associated with the female die part (42) is connected to (a) an external container (62) for collecting removed parts (22) of the foldable sheet material and (b) an external source of suction (60).

3. The flatbed die-cutting press of claim 1, wherein the female die part (42) is supported against a flat generally rectangular body (48) having therein a channel (46) which forms the suction cavity leading into the aperture(s) (44) of the female die part (42).

4. The flatbed die-cutting press of claim 3, wherein the flat generally rectangular body (48), with its suction channel (46) and with the female die part (42) supported thereagainst, constitutes a cutting plate module (70) of the die-cutting press (10) that is fittable in and removable from the cutting station (13) where it is interchangeable with different cutting plate modules.

5. The flatbed die-cutting press of claim 3, wherein the flat generally rectangular body (48) has a plurality of suction channels (46) that lead into apertures (44) in a plurality of female die parts (42), the suction channels (46) joining into one or more ducts (47) which lead(s) into an edge (49) of the flat generally rectangular body (48) for connection to an external source of suction (60).

6. The flatbed die-cutting press of claim 1, wherein the cutting tool assembly (40) comprises a plurality of apertured female die parts (42) each having at least one and preferably a series of apertures (44) defining a shape or shapes to be cut out, the female die parts (42) being arranged in rows and/or columns relative to the direction (d) of delivery of the sheet material (20), the female die parts (42) being associated with one or a plurality of suction channels (46) connectable to said source of suction (60), and wherein the opposite cutting part (50) has a plurality of corresponding cutters (54) in register with the female die parts (42).

7. A cutting plate module (70) of a flatbed die-cutting press according to claim 1, which module is fittable in and removable from a cutting station (13) of the flatbed die-cutting press (10) where it is interchangeable with different cutting plate modules, wherein said module (70) comprises:
at least one apertured female die part (42) having therethrough at least one and preferably a series of apertures (44) defining a shape to be cut out by a corresponding cutter or cutters (54), whose outline defines a shape or shapes to be cut out wherein the shape or shapes to be cut out have a section less than 2 mm, possibly less than 1 mm, and in particular extends over an area of at least several square centimeters that contains a group of cut-outs comprising a plurality of straight or curved lines or strokes all having a section less than 2 mm, possibly less than 1 mm, along all or a substantial part of their length;
a flat generally rectangular body (48) on which the female die part is supported with one face facing outwards towards said cutter(s) (54) when the module (70) is fitted in a cutting station (13) of the flatbed die-cutting press (10); and
at least one suction channel (46) in the support body (48) that leads into the side of said aperture(s) (44) in the female die part(s) (42) facing away from the cutter(s) (54), the suction channel (46) being connectable to a source of suction (60) whereby when the module (70) is fitted in a cutting station (13) of the flatbed die-cutting press (10), and during operation of the press, parts (22) that are cut out of sheets (20) of the board material are removable by suction through said aperture(s) (44) and into the suction channel(s) (46).

8. A method of mass producing foldable blanks from sheets (20) of foldable paper or board material having therein a cut-out shape or group of cut-out shapes that have a section less than 2 mm, possibly less than 1 mm, and in particular a group of cut-out shapes (24) that together form a complex shape whose outline extends over an area of at least several square centimeters that contains a group of cut-outs comprising a plurality of straight or curved lines or strokes all having a section less than 2 mm, possibly less than 1 mm, along all or a substantial part of their length, in a flatbed die-cutting press (10) according to claim 1, which comprises engaging the male cutter (54) in the aperture(s) (44) of the female die part (42) to cut the sheets 20 of paper or board material with cut out part(s) (24) having the shape of the aperture(s) (44), and applying suction to said suction cavity (46) whereby parts (22) that are cut out from the sheet material (20) are removed by suction through said aperture(s) (44) and into the suction cavity (46).

9. The method of claim 8, wherein the flatbed die-cutting press(10) operates at a rate of up to 14000 sheets/hour, possibly in the range 6000-12000 sheets/hour.

10. The method of claim 8, wherein the group of cut-outs (24) in the cut sheet material has, between the cut-outs at the periphery of said area, a non-cut out part or parts (28) that is/are connected to the surrounding sheet material (20).

11. The method of claim 8, wherein the foldable blank is a blank of a cigarette package in particular for forming the outer shell of a flip-top cigarette package.

12. The method of claim 8, which is followed by a conversion operation, preferably in a subsequent pass in the same flatbed die-cutting press (10) equipped with appropriate cutting and creasing dies, and a stripping operation to produce a plurality of blanks from each sheet, each blank having one or more cut-outs (24) that each form a shape whose outline extends over an area of several square centimetres.

13. The method of claim 12, which is followed by a subsequent folding operation to fold the blanks to produce folded sheet material objects, in particular packets, wherein each packet or other folded object has on an outside face at least one area each with one or more of said cut-outs (24) that constitute an emblem on the outside of the packet or other folded object.

14. The method of claim 13, wherein the folded sheet material objects are cigarette packages, in particular the outer shells of flip-top cigarette packages.
